(19) United States
(12) Patent Application Publication
(10) Pub. No.: US 2026/0359024 A1
(43) Pub. Date: Nov. 12, 2026

(54) MECHANISM TO APPLY TRANSFORMATIONS WITHOUT INTERMEDIATE REPRESENTATIONS

(71) Applicant: HUAWEI TECHNOLOGIES CO., LTD., SHENZHEN (CN)

(72) Inventors: Seyed Aryan Vahabpour, Kanata (CA); Jinman ZHAO, Kanata (CA); Xingyu YUE, Kanata (CA); Kai-Ting Amy WANG, Kanata (CA)

(73) Assignee: HUAWEI TECHNOLOGIES CO., LTD., SHENZHEN (CN)

(21) Appl. No.: 19/204,104

(22) Filed: May 9, 2025

(51) Int. Cl. G06F 8/41; G06F 8/72

(52) U.S. Cl. CPC G06F 8/4435; G06F 8/72

(57) ABSTRACT

Methods, apparatus, and systems for optimizing computer code are provided. In embodiments, a representation comprising constants that indicate the ordering of statements in relation to loop nests in the computer code is generated. The structure of the loop nests is recovered from the representation by modelling the constants as nodes in a mathematical graph and determining the shortest path between each consecutive pair of nodes. Each shortest path indicates the transitions between the corresponding statements that are needed to recover the structure of the loop nests. By representing the code by constants, the representation, rather than the code itself, can be communicated among different agents specialized for different aspects of code optimization.

### CROSS-REFERENCE TO RELATED APPLICATIONS

This is the first application filed for the present invention.

### FIELD OF THE INVENTION

The present application pertains to computing systems and in particular to methods and apparatus for computer code optimization.

### BACKGROUND

When being compiled, computer code can be optimized, such as through loop optimizations, to improve the code's performance on single core and/or multi-core computing devices. Among approaches for optimizing code is polyhedral optimization, which can provide precise analysis of the code and straightforward specification of transformations, such as for interchanging, tiling, distributing, parallelizing, or fusing loops. Polyhedral optimization is particularly useful in optimizing code with many dependencies, wherein polyhedral models can be used to rigorously verify the preservation of such dependencies and the correctness of the code following manual or automatic transformations. To implement polyhedral optimization, automatic compilers can be used. With automatic compilers, the entire code is transformed all at once using a cost function and a linear programming solver. Automatic compilers, however, are typically too narrow in scope for addressing diverse or application-specific performance goals, and they lack the flexibility for incorporating user-defined objectives and manual transformations, which can result in sub-optimal performance.

Another implementation technique is multi-agent optimization. Here, multiple optimization agents are used, which may be associated with different devices, and each agent may be specialized for a respective type of optimization, such as tiling, distributing, or interchanging loops. Multi-agent optimization, however, typically involves communicating large amounts of data between agents, much of which may not be needed by each individual agent. This inter-agent communication can form a bottleneck during optimization.

Various approaches have been proposed for reducing communication demands while maintaining consistency during multi-agent optimization. One approach is to generate an intermediate representation (IR) for the code and apply the transformations to the IR at each agent successively, whereby a new IR is generated with the application of each successive transformation. However, retaining the IR typically requires large amounts of memory and generating each new IR is time consuming. In another approach, nested loops are split into perfectly nested computations for separate transformation; however, this currently requires a performance engineer to split the loop nests.

Therefore, there is a need for methods and apparatus for code optimization, especially for multi-agent optimization, that obviate or mitigate one or more limitations of the prior art.

This background information is provided to reveal information believed by the applicant to be of possible relevance to the present invention. No admission is necessarily intended, nor should be construed, that any of the preceding information constitutes prior art against the present invention.

### SUMMARY

An object of embodiments of the present disclosure is to provide methods, systems and apparatus for optimizing computer programs.

A first aspect of the present disclosure is to provide a computer-implemented method. The method may comprise receiving a representation of a computer program. The computer program may include one or more affine loop nests among a series of statements. The representation may define a series of constants corresponding to the series of statements, with each constant indicating a respective ordering for the corresponding statement in accordance with the one or more affine loop nests. The method may further comprise determining, for each statement of the series of statements, a respective shortest path between the constant corresponding to the respective statement and the constant corresponding to a respective next statement among the series of statements. Each shortest path may define a respective set of one or more predefined instructions for transitioning between the respective statement and the respective next statement. The method may still further comprise obtaining, in accordance with the respective shortest path of each statement of the series of statements, the one or more affine loop nests of the computer program.

In some embodiments of the first aspect, each predefined instruction may be selected from the group consisting of loop initiation, loop termination, and statement continuation.

In some embodiments of the first aspect, the method may further comprise modifying, in accordance with the one or more affine loop nests of the computer program, the representation of the computer program with at least one loop transformation to produce an updated representation of the computer program. In some of these embodiments, each one of the at least one loop optimization may be selected from the group comprising loop distribution, loop tiling, loop fusion, loop interchange, and loop parallelization.

In some embodiments of the first aspect, determining, for each statement of the series of statements, the respective shortest path may include: representing the constant corresponding to the respective statement as a respective start node of a respective mathematical graph; representing the constant corresponding to the respective next statement as a respective target node of the respective mathematical graph; and identifying the respective set of one or more predefined instructions by a corresponding set of one or more edges connecting, in the respective mathematical graph, the respective start node to the respective target node.

In some embodiments of the first aspect, determining, for each statement of the series of statements, the respective shortest path may include: generating a queue having a front position and including thereat the constant corresponding to the respective statement; and performing a set of actions for a search for the respective shortest path until the respective shortest path is identified. The set of actions may include: identifying a current constant corresponding to the front position of the queue; generating, from the current constant, a set of candidate constants by a corresponding set of predefined instructions; removing the current constant from the queue; adding each candidate constant to the queue; and identifying the respective shortest path when one candidate constant matches the constant corresponding to the respective next statement. In some of these embodiments, the set of predefined instructions may include a loop initiation, a loop termination, and a statement continuation. In some embodiments, each candidate constant may be added to the queue only when the respective candidate constant, in accordance with one or more predetermined rules, advances the search towards the constant corresponding to the respective next statement. In some of these embodiments, the set of actions may further include adding each candidate constant to a record of unique candidate constants only when the respective candidate constant, in accordance with the one or more predetermined rules, advances the search towards the constant corresponding to the respective next statement and only when the respective candidate constant is absent from the record of unique candidate constants. In addition, each candidate constant may be added to the queue only when the respective candidate constant, in accordance with the one or more predetermined rules, advances the search towards the constant corresponding to the respective next statement and only when the respective candidate constant is absent from the record of unique candidate constants.

In some embodiments of the first aspect, for each statement of the series of statements, the respective shortest path may be determined using one of: a Djikstra technique; a Floyd Warshall technique; and a Bellman Ford technique.

A second aspect of the present disclosure is to provide a method to be performed by a computing device. The method may comprise: receiving a computer program including one or more affine loop nests among a series of statements; generating a representation of the computer program, the representation defining a series of constants corresponding to the series of statements, with each constant indicating a respective ordering for the corresponding statement in accordance with the one or more affine loop nests; sending, to one optimization agent of a set of optimization agents, the representation of the computer program, with each optimization agent of the set of optimization agents configured to update, in accordance with the one or more affine loop nests, the representation of the computer program by a respective type of loop optimization; receiving, from an other optimization agent of the set of optimization agents, an updated representation of the computer program modified according to the respective type of loop optimization of each optimization agent of the set of optimization agents; and obtaining, in accordance with the updated representation of the computer program, an updated computer program including one or more optimized loop structures among the one or more statements.

In some embodiments of the second aspect, the one optimization agent and the other optimization agent may be a same optimization agent.

In some embodiments of the second aspect, the method may further comprise, by the computing device: receiving, from the one optimization agent of the set of optimization agents, a partially updated representation of the computer program modified according to the respective type of loop optimization of the one optimization agent; and sending, to a further optimization agent of the set of optimization agents, the partially updated representation of the computer program. In some of these embodiments, the one other optimization agent and the further optimization agent may be a same optimization agent.

In some embodiments of the second aspect, each type of loop optimization may be selected from the group comprising loop distribution, loop tiling, loop fusion, loop interchange, and loop parallelization.

In some embodiments of the second aspect, at least one optimization agent of the set of optimization agents may be located at a further computing device coupled to the computing device.

A third aspect of the present disclosure is to provide a system for optimizing a computer program including one or more affine loop nests among a series of statements. The system may comprise a lead computing device and a set of agent computing devices coupled to the lead computing device. The lead computing device may be configured to: receive the computer program; and generate a representation of the computer program, with the representation defining a series of constants corresponding to the series of statements where each constant indicates a respective ordering for the corresponding statement in accordance with the one or more affine loop nests. Each agent computing device may be configured to: receive, from the lead computing device or one other agent computing device of the set of further computing devices, the representation of the computer program; determine, for each statement of the series of statements, a respective shortest path between the constant corresponding to the respective statement and the constant corresponding to a respective next statement among the series of statements, with each shortest path defining a respective set of one or more predefined instructions for transitioning between the respective statement and the respective next statement; identify, in accordance with the respective shortest path of each statement of the series of statements, the one or more affine loop nests of the computer program; modify, in accordance with the one or more affine loop nests of the computer program, the representation of the computer program with at least one loop transformation corresponding to a respective type of loop optimization; and provide the representation of the computer program.

In some embodiments of the third aspect, the lead computing device may be further configured to: receive, from one agent computing device of the set of agent computing devices, the representation of the computer program modified according to the respective type of loop optimization of each agent computing device of the set of agent computing devices; and obtain, in accordance with the representation of the computer program received from the one agent computing device, an updated computer program including one or more optimized loop structures among the one or more statements.

In some embodiments of the third aspect, each predefined instruction may be selected from the group consisting of loop initiation, loop termination, and statement continuation. In some embodiments, each type of loop optimization may be selected from the group comprising loop distribution, loop tiling, loop fusion, loop interchange, and loop parallelization.

Another aspect of the present disclosure is to provide a computer readable storage medium, comprising one or more instructions, wherein when the one or more instructions are run on a computer, with the computer performing any of the methods disclosed herein.

Another aspect of the present disclosure is to provide a non-transitory computer-readable medium storing instructions. The instructions may cause a processor in a device to implement any of the methods disclosed herein.

Another aspect of the present disclosure is to provide a device configured to perform any of the methods disclosed herein.

Another aspect of the present disclosure is to provide a processor, configured to execute instructions to cause a device to perform any of the methods disclosed herein.

Another aspect of the present disclosure is to provide an integrated circuit configured to perform any of the methods disclosed herein.

Another aspect of the present disclosure is to provide a module comprising: one or more circuits for performing any of the methods disclosed herein.

Another aspect of the present disclosure is to provide an apparatus comprising: one or more processors functionally connected to one or more memories for performing any of the methods disclosed herein.

Another aspect of the present disclosure is to provide an apparatus configured to perform any of the methods disclosed herein. In some embodiments, the apparatus may comprise one or more units configured to perform any of the methods disclosed herein.

Another aspect of the present disclosure is to provide one or more non-transitory, computer-readable storage media comprising computer-executable instructions, wherein the instructions, when executed, cause at least one processing unit, at least one processor, or at least one circuits to perform any of the methods disclosed herein.

Another aspect of the present disclosure is to provide one or more computer-readable storage media storing a computer program, wherein, when the computer program is executed by an apparatus, the apparatus is enabled to implement any of the methods disclosed herein.

Another aspect of the present disclosure is to provide a computer program product including one or more instructions, wherein, when the instructions are executed by an apparatus, the apparatus is enabled to implement any of the methods disclosed herein.

Another aspect of the present disclosure is to provide a computer program, wherein, when the computer program is executed by a computer, an apparatus is enabled to implement any of the methods disclosed herein.

Embodiments of the first aspect may facilitate efficient optimization of computer programs that is furthermore flexible and automated. Embodiments may enable multi-agent optimization that uses less memory and/or communication bandwidth.

Embodiments have been described above in conjunctions with aspects of the present invention upon which they can be implemented. Those skilled in the art will appreciate that embodiments may be implemented in conjunction with the aspect with which they are described, but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE FIGURES

Further features and advantages of the present invention will become apparent from the following detailed description, taken in combination with the appended drawings, in which:

FIG. 1 shows an example scenario of code optimization towards which embodiments of the present disclosure may be implemented.

FIG. 2 shows a flowchart of a method for recovering loop structures from a constants representation, in accordance with embodiments of the present disclosure.

FIG. 3 shows a flowchart of a method for multi-agent optimization, in accordance with embodiments of the present disclosure.

FIG. 4 shows a schematic for an example implementation of recovery of loop structures from a constants representation, in accordance with embodiments of the present disclosure.

FIG. 5 shows a schematic for an example implementation of multi-agent optimization, in accordance with embodiments of the present disclosure.

FIG. 6 shows a schematic of an apparatus for code optimization according to embodiments of the present disclosure.

FIG. 7 shows a schematic of an embodiment of an electronic device that may implement at least part of the methods and features of the present disclosure.

It will be noted that throughout the appended drawings, like features are identified by like reference numerals.

### DETAILED DESCRIPTION

Embodiments of the present disclosure are generally directed, first, towards generating a representation of computer code according to constants that indicate the ordering of the code's statements in relation to affine loop nests within the code and, second, towards providing a method for recovering the structure of the code from this representation. In embodiments, the structure of the affine loop nests may be recovered from the representation by modelling each constant corresponding to each statement as a respective node in a mathematical graph and searching for the shortest path between consecutive nodes. The shortest path may indicate instructions, such as the beginning or ending of a loop, for transitioning between consecutive statements of the code. Embodiments may be used towards enabling multi-agent optimization, wherein the representation of constants may be communicated among agents rather than the code itself and each agent may recover the structure of the code from the representation. Each agent may apply respective transformations to optimize the code and may produce an updated representation for further communication.

Embodiments of the present disclosure may facilitate more efficient optimization of computer programs or code, while also being flexible, automated, and simple. By using a representation based on the constants, embodiments may enable multi-agent optimization that uses less memory and communication bandwidth than other techniques currently available.

The present disclosure sets forth various embodiments via the use of block diagrams, flowcharts, and examples. Insofar as such block diagrams, flowcharts, and examples contain one or more functions and/or operations, it will be understood by a person skilled in the art that each function and/or operation within such block diagrams, flowcharts, and examples can be implemented, individually or collectively, by a wide range of hardware, software, firmware, or combination thereof.

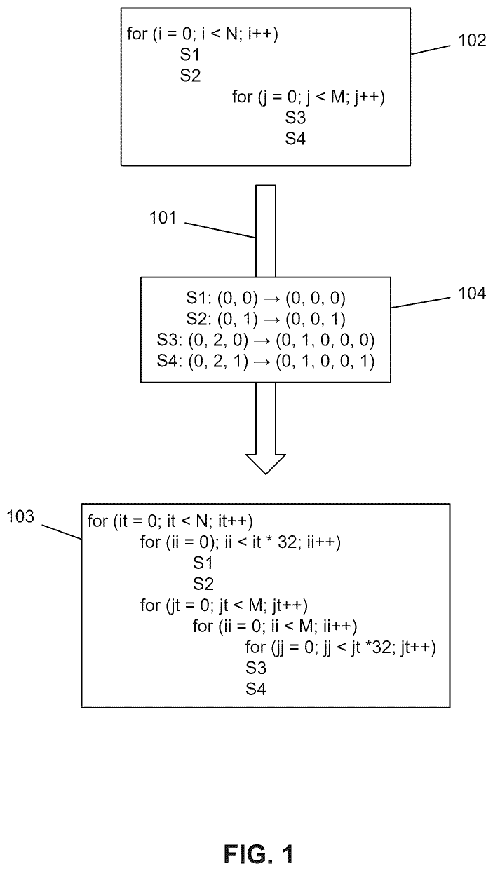

FIG. 1 shows an example of a scenario to which embodiments of the present disclosure may be implemented. In the example, a tiling optimization 101 is applied to a computer code 102 to produce an optimized computer code 103. The computer code 102 may be a portion of a computer program that can be stored in memory at a computing device and executed by a processor thereof. In the example of FIG. 1, the computer code 102 includes two ‘for’ loops, one nested inside the other (i.e., an inner loop nested within an outer loop) and together forming a loop nest. The outer loop includes two statements (S1 and S2), and the inner loop includes an additional two statements (S3 and S4). The outer loop increments over index ‘i’, up to limit ‘N’, while the inner loop increments over index ‘j’, up to limit ‘M’. The loop nest formed by the inner and outer loops is furthermore affine, meaning elements of the statements that are accessed on each loop iteration are only affine functions of the loop indices (i.e., ‘i’ and ‘j’) and further that each of the upper bound and lower bound for the loop are affine functions as well. The tiling optimization 101 causes the depth of the loops of the computer code 102 to shift, such that a further level of nesting is introduced and new indices ‘it’, ‘ii’, ‘jt’ and ‘jj’ are introduced in the optimized computer code 103.

Each statement in the computer code 102 may be represented by a respective domain, a respective scattering function, and a respective constant. Each domain may indicate by one or more respective linear inequalities the bounds over which a statement may be iterated; for example, the respective domain for the third statement in the computer code 102 may be ‘0≤i≤N; 0≤j≤M’. Each scattering function may map each iteration within the respective domain to a multidimensional logical date dimension. For further clarity, the respective scattering function for each statement may assign values (e.g., vectors or integers) to each of the indices over which the respective statement iterates and may be an affine function. For example, the respective scattering function for the third statement in the computer code 102 may be ‘i+2×(i×M+j)’. Each constant may indicate a respective ordering for the respective statement within the loops to which the respective statement belongs. In other words, each constant may indicate a respective ordering for the respective statement in accordance with the loop nests of the computer code 102. For further clarity, each digit of a constant may indicate the order of the respective statement in relation to other statements and/or loops. Each constant may uniquely indicate the position of the respective statement such that: the last digit of the respective constant indicates the order of the respective statement within the innermost loop of any loop nests to which the respective statement belongs; and any other digits of the respective constant indicate the order of the innermost loop and any other loops to which the respective loop belongs within the computer code. For example, a statement corresponding to the constant ‘(1, 0, 2)’ may indicate that the statement is the third statement in an inner loop nested inside an outer loop, wherein the inner loop is a first loop within the outer loop and the outer loop is a second loop at the outermost loop depth. In the example of FIG. 1, the constants for the series of statements [S1, S2, S3, and S4] may be correspondingly [(0, 0), (0, 1), (0, 2, 0), and (0, 2, 1)]. Thus, the constants (0, 0) and (0, 1) for the first and second statements, respectively, indicate that both statements belong to a first loop of a code and the second statement follows after the first statement in that loop. The tiling optimization 101 may cause the respective constant of each statement to change, as shown by the transitions 104 in FIG. 1.

Embodiments of the present disclosure are generally directed towards providing methods for recovering the structure of affine loop nests of a computer program based on the constants corresponding to the statements of the computer program. Recovery of these structures may enable the constants, rather than the code or an intermediate representation of the computer program, to be communicated among agents for multi-agent optimization, which may thereby alleviate the communication bottlenecks currently inherent in multi-agent optimization. Determining a linear function or other transformation for recovering the structure of affine loop nests from constants is typically a non-trivial task. To solve this problem, embodiments of the present disclosure may model the constants as nodes of a mathematical graph and use a shortest-path approach.

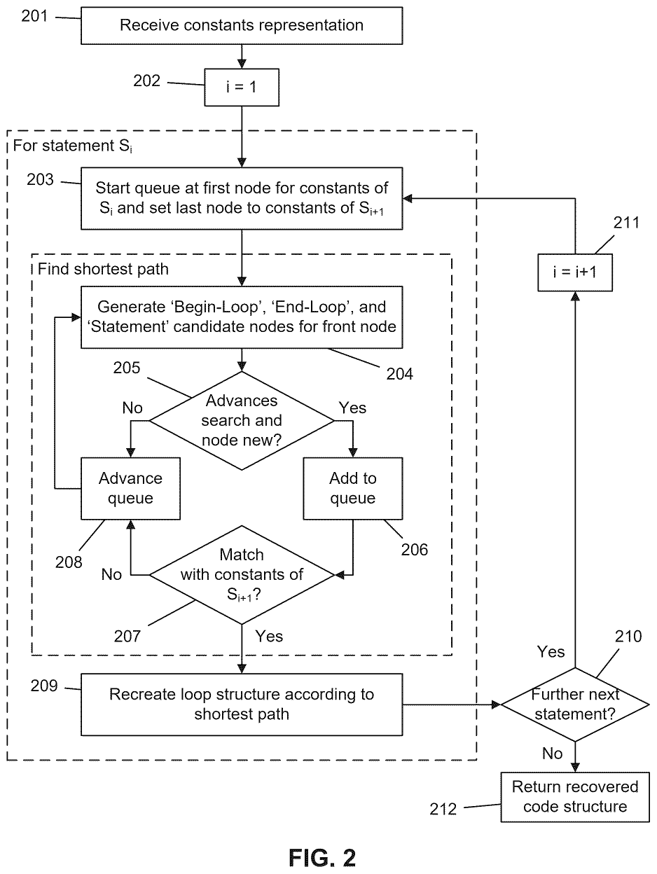

FIG. 2 shows a flowchart of a method in accordance with embodiments of the present disclosure. The method may be performed to recover the structure of one or more affine loop nests included among a series of statements in a computer program, based on a series of constants corresponding to the series of statements. At action 201, a representation (referred to herein as a ‘constants representation’) defining the series of constants may be received. A set of actions may then be performed for each statement Sᵢ of the series of statements, where ‘i’ is an index over the series of statements. The set of actions may be performed to determine, for each statement of the series of statements, a respective shortest path between the constant corresponding to the respective statement (i.e., the i^{th} statement) and the constant corresponding to a respective next statement among the series of statements (i.e., the i+1^{th} statement). Each shortest path may define a respective set of one or more predefined instructions for transitioning between the respective statement and the respective next statement. In embodiments, each predefined instruction may be a loop initiation (i.e., an instruction for beginning a loop immediately after the respective statement), a loop termination (i.e., an instruction for ending an already existing loop with the respective statement), or a statement continuation (i.e., an instruction to immediately follow the respective statement with the respective next statement). To determine each shortest path, the constants and predefined instructions may be modelled as nodes and edges, respectively, in a mathematical graph formulated according to mathematical graph theory. In this formulation, for each statement, the constant corresponding to the respective statement may be represented as a respective start node of a respective mathematical graph, the constant corresponding to the respective next statement may be represented as a respective target node of the respective mathematical graph, and the respective set of one or more predefined instructions may be identified by a corresponding set of one or more edges connecting, in the respective mathematical graph, the respective start node to the respective target node. To determine the respective shortest path for each statement, namely the set of one or more edges between the respective start node and the last respective node, different techniques may be used. In the following description of actions 204 to 208, a breadth-first search (BFS) technique is provided for determining each shortest path. The person skilled in the art will appreciate that other techniques may be used for determining each shortest path, such as Djikstra, Floyd Warshall, or Bellman Ford techniques.

At action 202, a first statement (i.e., i=1) may be identified from among the series of statements for commencing the set of actions, which may proceed through actions 203 to 209 and may be performed for the first statement and each subsequent statement among the series of statements. At action 203, a queue may be generated, which may represent an ordered list of nodes to be explored when searching for the shortest path between statement Sᵢ and statement Sᵢ₊₁. The queue may have a first position and may be generated with the respective start node (i.e., the constant corresponding to statement Sᵢ) at this first position. As described above, the constants corresponding to the respective next statement Sᵢ₊₁ may form the target node for the search. Actions 204 to 208 may encompass the search for the shortest path. At action 204, a current constant may be identified as that corresponding to the front position of the queue (i.e., a “front node”), and a set of candidate constants (i.e., “candidate nodes” or “children nodes”) may be generated from the current constant. The set of candidate constants may be generated by a corresponding set of predefined instructions, which may include the loop initiation (‘Begin-Loop’), loop termination (‘End-Loop’), and statement continuation (‘Statement’) instructions described previously. At action 205, each candidate constant may be evaluated for whether the respective candidate constant has not been seen before in the search (i.e., whether it is a new node) and whether the respective candidate constant advances the search towards the constant corresponding to the respective next statement (i.e., towards the target node). Advancement of the search may be evaluated according to one or more predetermined rules, which may be implementation-specific. The predetermined rules may include consideration of the form of the target node. They may further be selected to exclude invalid transitions between nodes, which, for example, might result from a loop termination instruction being applied to a constant having no loop depth (e.g., a constant of ‘(5)’). Whether each candidate constant has been seen may be evaluated according to a record of unique candidate constants that have been seen in the search already. If a candidate constant has not been seen (e.g., it is absent from the record of unique candidate constants) and if that candidate constant advances the search, it may be added, at action 206, to the queue and may be evaluated, at action 207, for whether it matches the constant corresponding to the respective next statement (i.e., the search for the shortest path to the target node has been successful). In this case, the candidate constant may further be added to the record of unique candidate constants as well. If a candidate constant has been seen (e.g., it is present in the record of unique candidate constants) or if that candidate constant does not advance the search, it may be omitted from being added to the queue. Following the evaluations performed at actions 205 and 207, and if the search has not found a match to the constant corresponding to the respective next statement, the queue may be advanced, at action 208, to the next candidate constant in the queue and actions 204 to 208 may repeat. The front position of the queue may be maintained during the search by removing the current constant identified in action 204 from the queue after the set of candidate constants is subsequently generated. If a candidate constant matches the constant corresponding to the respective next constant, as evaluated at action 207, the search for the shortest path may conclude. At action 209, any developments in the structure of the one or more affine loop nests (i.e., initiation or termination of loops) that occur between the respective statement and the respective next statement may be recovered according to the predefined instructions that generated the candidate nodes and that resulted in the match to the target node (i.e., the shortest path).

At action 210, the constants representation may be inspected to determine whether there exists a further next statement (i.e., a Sᵢ₊₂ statement) respective to the statement for which the shortest path was previously determined (i.e., the Sᵢ statement). If this further next statement exists, the index ‘i’ may be incremented, at action 211, and actions 203 to 209 may be repeated to determine the shortest path for the next statement. If the further next statement does not exist, this may indicate that the statement for which the shortest path was previously determined was the penultimate statement of the series of statements in the computer program. In this case, the next statement (i.e., the Sᵢ₊₁ statement) may be the last statement of the series of statements in the computer program, and thus, only loop terminations for any already existing loops may be relevant. Next, the structure of the one or more affine loop nests for the computer program may be obtained, at action 212, in accordance with the respective shortest path determined for each statement of the series of statements.

In some embodiments of the method described in relation to FIG. 2, the method may not include maintaining a record of unique constants. In these cases, each candidate constant may be explored regardless of whether it has already been seen in the search. In some other embodiments, the method may not include evaluating whether each candidate constant advances the search towards the target node. In these cases, each candidate constant may be explored regardless of whether it advances the search.

Example 1 provided below shows a pseudocode, LoopStructure, that may be used to implement, at least in part, the method described in relation to FIG. 2. At line 2, a function RecoveryAlgorithm may be called and receive as input a constant corresponding to one statement and another constant corresponding the respective next statement, which may respectively be stored in variables ‘s’ (i.e., the start node) and ‘t’ (i.e., the target node). At line 3, a queue ‘Q’ may be generated, similarly to action 203 of FIG. 2. At line 4, a record for tracking unique constants ‘mark’ may be generated. At line 5, the start node may be added to the queue. At line 6, the start node may be recorded as being seen. At line 7, a search for the shortest path between the start node and the target node begins, similarly to actions 204 to 208, and continues until the target node is seen in the search. At line 8, a current node ‘current’ that corresponds to the node at the front of the queue may be identified, and at line 9, the queue may be updated by removing said node currently at its front. At lines 10 to 12, a set of candidate nodes (‘next_1’, ‘next_2’, and ‘next_3’ may be generated from the current node by a corresponding set of the loop initiation (‘ApplyBeginLoop’), loop termination (‘ApplyEndLoop’), and statement continuation (‘ApplyStatement’) instructions. At line 14, each candidate node may be evaluated for whether it advances the search according to one or more predetermined rules (‘check(next_i)’) and for whether it has been seen already (‘mark[next_i]==false’). If the candidate node advances the search and has been seen, it may be added to the queue, at line 15, and may be recorded as having now been seen, at line 16. If, during the search, a candidate node matching the target node is seen (i.e., ‘mark[t]==true’), the search may be terminated at line 19. At line 21, the structure of the code, namely the development of any affine loop nests, between the start node and the target node may be obtained, similarly to action 209.

### Example 1

1. LoopStructure
2. RecoveryAlgorithm(StartNode s, TargetNode t) {
3. Define the queue Q←Empty
4. Define map<State, Boolean> mark←Empty
5. Q.push(s)
6. mark[s]=true
7. while (mark[t]==false) {
   8. current=Q.front()
   9. Q.pop_front()
   10. next_1=ApplyBeginLoop(current)
   11. next_2=ApplyEndLoop(current)
   12. next_3=ApplyStatement(current)
   13. for i from 1 to 3:
      14. if (check(next_i)==true AND mark[next_i]==false) {
         15. Q.push(next_i)
         16. mark[next_i]=true;
   17. }
   18. if (mark[t]==true)
   19. break
20. }
21. Reiterate path s to t and return the structure of the code
22. }

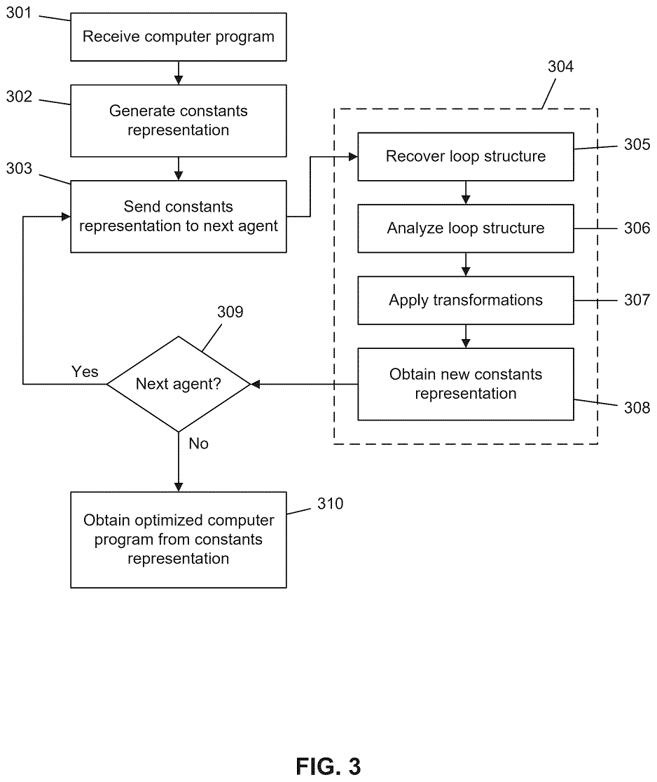

FIG. 3 shows a flowchart of a method for multi-agent optimization, in accordance with embodiments of the present disclosure. The method may be implemented by a computing device (i.e., a “lead computing device”) and may use a set of agents (i.e., “optimization agents”) to optimize a computer program. The computer program may include one or more affine loop nests among a series of statements, as described previously. Each agent may, for example, belong to a respective further computing device (i.e., a respective “agent computing device”) coupled to the computing device, or may, for another example, be a respective software agent implemented by the computing device. Each agent may be configured to update, in accordance with the one or more affine loop nests of the computer program, a constants representation received by the respective agent by a respective type of loop optimization. Each type of loop optimization may, for example, be one of loop distribution, loop tiling, loop fusion, loop interchange, and loop parallelization. The person skilled in the art will appreciate that any technique suitable for optimizing affine loop nests and/or that is amenable to a constants representation may be included as a type of loop optimization.

At action 301, the computer program may be received. At action 302, a constants representation may be generated for the computer program, which may define a series of constants corresponding to the series of statements of the computer program. At action 303, the constants representation may be sent to one agent of the set of agents. The one agent may then perform a set 304 of actions encompassing actions 305 to 308 in order to recover the structure of the one or more affine loop nests of the computer program and produce an updated constants representation modified to optimize the computer program. At action 305, the one agent may recover the structure of the one or more affine loop nests of the computer program by implementing the method described in relation to FIG. 2. The one agent may then analyze, at action 306, the structure of the one or more affine loop nests and, at action 307, determine and apply a respective at least one loop transformation to the obtained structure. Each loop transformation may be directed towards optimizing the computer program according to the respective type of loop optimization. At action 308, an updated constants representation of the computer program may be obtained from the transformed structure. Actions 307 and 308 may be said to modify the constants representation received by the one agent according to the at least one loop transformation.

The set 304 of actions may be repeated for each agent of the set of agents sequentially. In some embodiments, the sequential implementation among agents may follow a predetermined order, whereas in some other embodiments, the sequential implementation may be determined dynamically. If at action 309, there remains a further agent in the set of agents that has not yet been sent the constants representation to optimize the computer program, the further agent may be sent, at action 303, the constants representation, as updated by all the agents to have already performed the set 304 of actions. The constants representation sent in this case may be referred to as a partially updated constants representation. In some embodiments, the one agent may send the partially updated constants representation directly to the further agent, whereas in some other embodiments, the constants representation may be sent to the computing device, which may then send the partially updated constants representation to the further agent. After all the agents of the set of agents have been sent the constants representation for optimization, the last agent among the set of agents to be sent the constants representation may send the collectively updated constants representation (i.e., the constants representation updated by all agents of the set of agents) to the computing device. At action 310, the computing device may generate an updated computer program in accordance with the collectively updated constants representation. The updated computer program may include one or more optimized loop structures among the one or more statements, which may result from the respective at least one loop transformation applied by each agent of the set of agents.

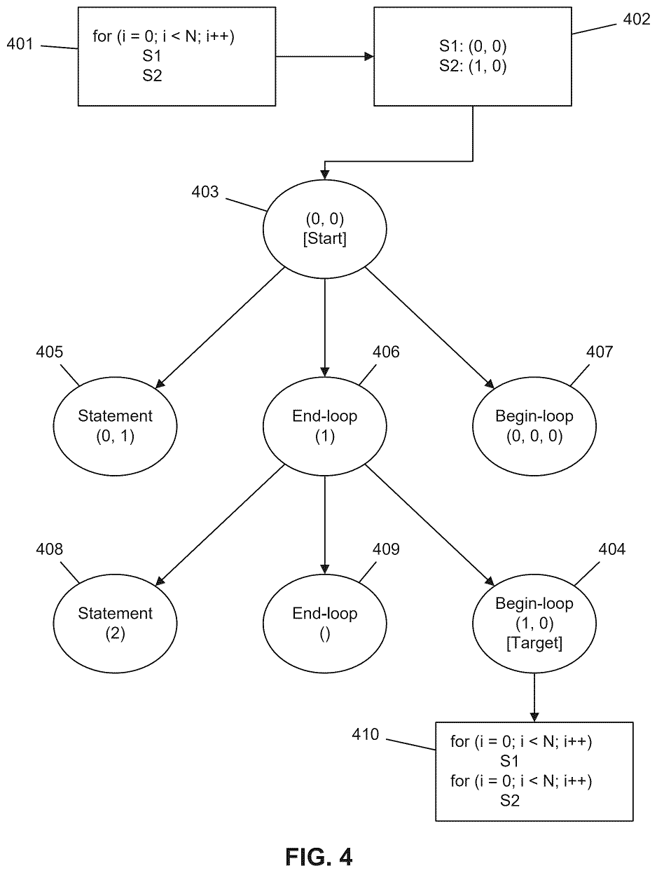

FIG. 4 shows a schematic for an example implementation of the recovery method described in relation to FIG. 2. Here, an initial code 401 belongs to a computer program and includes, within a ‘for’ loop, a first statement (S1) and a second statement (S2). The structure of any affine loop nests may have already been determined up to the initial code 401. A constants representation 402 accordingly indicates the respective constant for the first statement as ‘(0, 0)’ and that for the second statement as ‘(1, 0)’. An agent, for example, may use this constants representation 402 to recover the structure of the loops associated with the initial code 401. In the recovery, the respective constant for the first statement may form a start node 403, and the respective constant for the second statement may form a target node 404. The shortest path between the start node 403 and the target node 404 may then be determined by searching for the target node 404 from the start node 403. To begin the search, a first set of candidate nodes may be generated from the start node 403, which may include a first statement node 405, a first end-loop node 406, and a first begin-loop node 407. The first statement node 405 may be generated with a statement continuation instruction, the first end-loop node 406 may be generated with a loop termination instruction, and the first begin-loop node 407 may be generated with a loop initiation instruction. In accordance with one or more predetermined rules, the first statement node 405 and the first begin-loop node 407 may be determined to be not advancing the search, whereas the first end-loop node 406 may be determined to be advancing the search. Each of the first set of candidate nodes have not yet been seen and may be added to a record of unique candidate nodes. To continue the search, a second set of candidate nodes may be generated from the first end-loop node 407, which may include a second statement node 408, a second end-loop node 409, and a second begin loop node 404 (matching the target node 404). The second statement node 408 may be generated with a statement continuation instruction, the second end-loop node 409 may be generated with a loop termination instruction, and the third begin-loop node 404 may be generated with a loop initiation instruction. Because the second begin loop node 404 matches the target node 404, the search may terminate, with the shortest path between the start node 403 and the target node 404 being determined as a loop termination instruction followed by a loop initiation instruction. In accordance with the shortest path, a structure 410 equivalent to that for the initial code 401 may be recovered, wherein the ‘for’ loop containing the first statement is terminated and a further ‘for’ loop initiates thereafter.

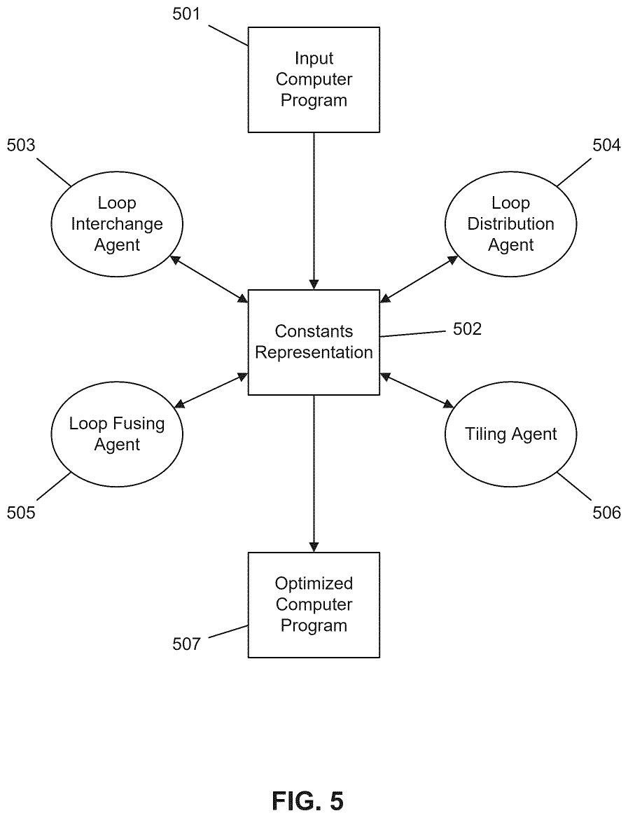

FIG. 5 shows a schematic of an example implementation of the multi-agent optimization method described in relation to FIG. 3. Here, a computer program 501 may be received, such as by a computing device. The computer program includes one or more affine loop nests among a series of statements. A constants representation 502 defining a series of constants corresponding to the series of statements may be generated. The constants representation 502 may be shared sequentially with each of a loop interchange agent 503, a loop distribution agent 504, a loop fusing agent 505, and a loop tiling agent 506, which may apply transformations according to a namesake type of loop optimization in order to optimize the computer program 501. Each agent may be configured to recover the structure of the one or more affine loop nests, and any transformations applied thereto previously, in accordance with the constants representation 502. Each agent may then analyze the structure and apply a respective one or more transformations of the respective type of loop optimization. Each agent may produce an updated constants representation 502 in accordance with the respective one or more transformations. The updated constants representation 502 may be sent to a next agent until all the agents have updated the constants representation 502. An optimized computer program 507 may be generated from the collectively updated constants representation 502 (i.e., the constants representation 502 updated by all the agents).

Embodiments of the present disclosure may be implemented using electronics hardware, software, or a combination thereof. In some embodiments, the invention may be implemented by one or multiple computer processors executing program instructions stored in memory. In some embodiments, the invention may be implemented partially or fully in hardware, for example using one or more field programmable gate arrays (FPGAs) or application specific integrated circuits (ASICs) to rapidly perform processing operations.

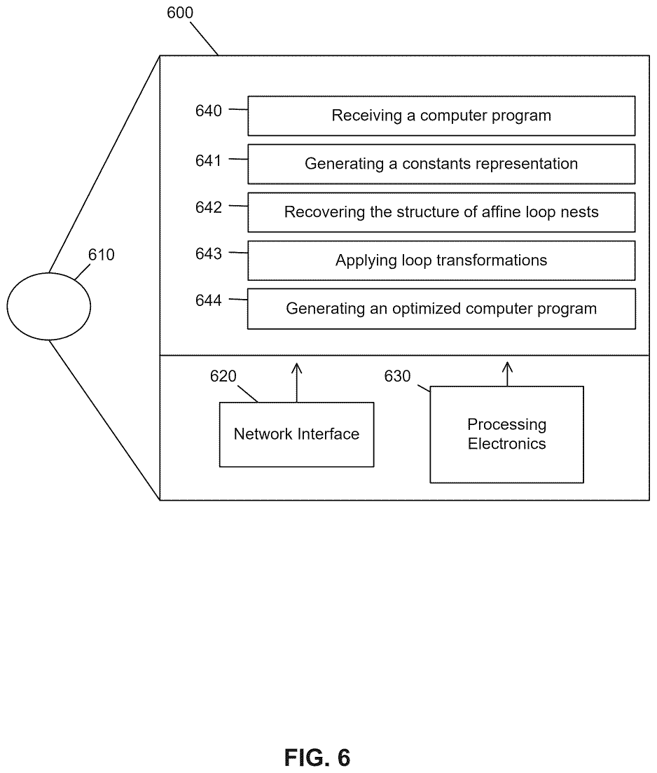

FIG. 6 shows an apparatus 600 for optimizing computer program, according to embodiments of the present disclosure. The apparatus 600 may be located at a node 610 of the network. The apparatus may include a network interface 620 and processing electronics 630. The processing electronics 630 may include a computer processor executing program instructions stored in memory, or other electronics components such as digital circuitry, including for example FPGAs and ASICs. The network interface 620 may include an optical communication interface or radio communication interface, such as a transmitter and receiver. The apparatus 600 may include several functional components, each of which may be partially or fully implemented using the underlying network interface 620 and processing electronics 630. Examples of functional components may include modules for receiving 640 a computer program, generating 641 a constants representation, recovering 642 the structure of affine loop nests, applying 643 loop transformations, and generating 644 an optimized computer program.

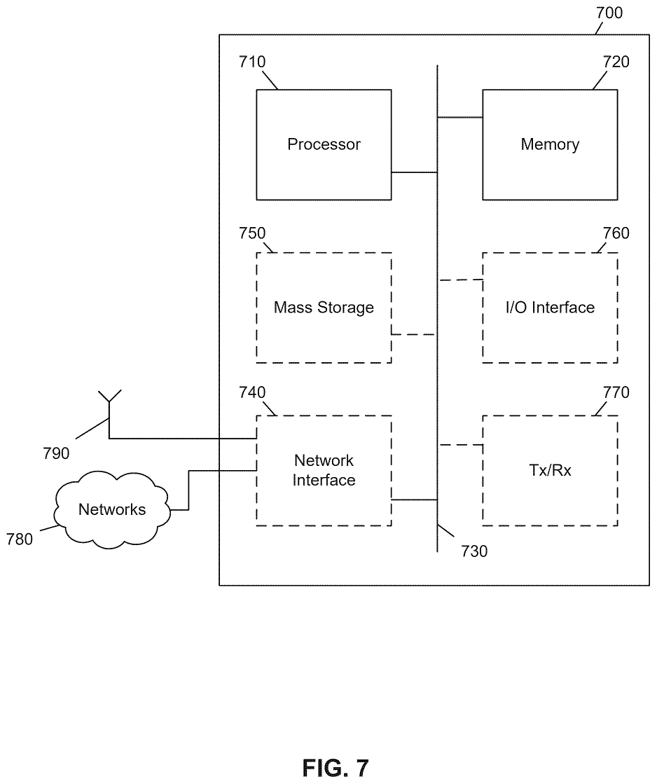

FIG. 7 shows a schematic diagram of an electronic device 700 that may perform any or all of the operations of the above methods and features explicitly or implicitly described herein, according to different embodiments of the present disclosure. For example, a computer equipped with network function may be configured as electronic device 700. The electronic device 700 may be used to implement the apparatus 600 of FIG. 6, for example. The electronic device 700 may further be used to implement the methods described in relation to FIGS. 2 and 3, for example.

As shown, the electronic device 700 may include a processor 710, such as a Central Processing Unit (CPU) or specialized processors such as a Graphics Processing Unit (GPU) or other such processor unit, memory 720, and a bi-directional bus 730 to communicatively couple the components of electronic device 700. Electronic device 700 may also optionally include a network interface 740, non-transitory mass storage 750, an I/O interface 760, and a transceiver 770. According to certain embodiments, any or all of the depicted elements may be utilized, or only a subset of the elements. Further, the electronic device 700 may contain multiple instances of certain elements, such as multiple processors, memories, or transceivers. Also, elements of the hardware device may be directly coupled to other elements without the bi-directional bus 730. Additionally or alternatively to a processor and memory, other electronics, such as integrated circuits, may be employed for performing the required logical operations.

The memory 720 may include any type of tangible, non-transitory memory such as static random access memory (SRAM), dynamic random access memory (DRAM), synchronous DRAM (SDRAM), read-only memory (ROM), any combination of such, or the like. The mass storage element 750 may include any type of tangible, non-transitory storage device, such as a solid state drive, hard disk drive, a magnetic disk drive, an optical disk drive, USB drive, or any computer program product configured to store data and machine executable program code. According to certain embodiments, the memory 720 or mass storage 750 may have recorded thereon statements and instructions executable by the processor 710 for performing any of the aforementioned method operations described above.

Network interface 740 may include at least one of a wired network interface and a wireless network interface. The network interface 740 may include a wired network interface to connect to a communication network 780 and may also include a radio access network interface 790 for connecting to the communication network 780 or other network elements over a radio link. The network interface 740 enables the electronic device 700 to communicate with remote entities such as those connected to the communication network 780.

It will be appreciated that, although specific embodiments of the technology have been described herein for purposes of illustration, various modifications may be made without departing from the scope of the technology. The specification and drawings are, accordingly, to be regarded simply as an illustration of the invention as defined by the appended claims, and are contemplated to cover any and all modifications, variations, combinations or equivalents that fall within the scope of the present invention. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Further, each operation of the method may be executed on any computing device, such as a personal computer, server, PDA, or the like and pursuant to one or more, or a part of one or more, program elements, modules or objects generated from any programming language, such as C++, Java, or the like. In addition, each operation, or a file or object or the like implementing each said operation, may be executed by special purpose hardware or a circuit module designed for that purpose.

Through the descriptions of the preceding embodiments, the present invention may be implemented by using hardware only or by using software and a necessary universal hardware platform. Based on such understandings, the technical solution of the present invention may be embodied in the form of a software product. The software product may be stored in a non-volatile or non-transitory storage medium, which can be a compact disk read-only memory (CD-ROM), USB flash disk, or a removable hard disk. The software product may include a number of instructions that enable a computer device (personal computer, server, or network device) to execute the methods provided in the embodiments of the present invention. For example, such an execution may correspond to a simulation of the logical operations as described herein. The software product may additionally or alternatively include number of instructions that enable a computer device to execute operations for configuring or programming a digital logic apparatus in accordance with embodiments of the present invention.

The word “a” or “an” when used in conjunction with the term “comprising” or “including” in the claims and/or the specification may mean “one”, but it is also consistent with the meaning of “one or more”, “at least one”, and “one or more than one” unless the content clearly dictates otherwise. Similarly, the word “another” may mean at least a second or more unless the content clearly dictates otherwise. The phrase “at least one” means one or more, and “a plurality of” means two or more. In addition, “and/or” describes an association relationship of associated objects, and indicates that there may be three relationships. For example, A and/or B may indicate cases including “only A”, “both A and B”, and “only B”, where A and B may be singular or plural. The character “/” generally indicates that the associated objects are in an OR relationship. “At least one of the following items” or a similar expression thereof refers to any combination of these items, including any combination of a single item or a plurality of items. For example, “at least one of a, b, or c” may represent “a”, “b”, “c”, “a and b”, “a and c”, “b and c”, or “a, b and c”, where a, b, and c may be a single or multiple form.

The terms “coupled”, “coupling” or “connected” as used herein can have several different meanings depending on the context in which these terms are used. For example, as used herein, the terms coupled, coupling, or connected can indicate that two elements or devices are directly connected to one another or connected to one another through one or more intermediate elements or devices via an electronic element depending on the particular context. The term “and/or” herein when used in association with a list of items means any one or more of the items comprising that list.

Although a combination of features is shown in the illustrated embodiments, not all of them need to be combined to realize the benefits of various embodiments of this disclosure. In other words, a system or method designed according to an embodiment of this disclosure will not necessarily include all features shown in any one of the Figures or all portions schematically shown in the Figures. Moreover, selected features of one example embodiment may be combined with selected features of other example embodiments.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

What is claimed is

1. A computer-implemented method comprising:
receiving a representation of a computer program, the computer program including one or more affine loop nests among a series of statements, the representation defining a series of constants corresponding to the series of statements, each constant indicating a respective ordering for the corresponding statement in accordance with the one or more affine loop nests;
determining, for each statement of the series of statements, a respective shortest path between the constant corresponding to the respective statement and the constant corresponding to a respective next statement among the series of statements, each shortest path defining a respective set of one or more predefined instructions for transitioning between the respective statement and the respective next statement;
and
obtaining, in accordance with the respective shortest path of each statement of the series of statements, the one or more affine loop nests of the computer program.

2. The method of claim 1 wherein each predefined instruction is selected from the group consisting of loop initiation, loop termination, and statement continuation.

3. The method of claim 1 further comprising:
modifying, in accordance with the one or more affine loop nests of the computer program, the representation of the computer program with at least one loop transformation to produce an updated representation of the computer program.

4. The method of claim 3 wherein each one of the at least one loop optimization is selected from the group comprising loop distribution, loop tiling, loop fusion, loop interchange, and loop parallelization.

5. The method of claim 1 wherein determining, for each statement of the series of statements, the respective shortest path includes:
representing:
the constant corresponding to the respective statement as a respective start node of a respective mathematical graph,
and
the constant corresponding to the respective next statement as a respective target node of the respective mathematical graph;
and
identifying the respective set of one or more predefined instructions by a corresponding set of one or more edges connecting, in the respective mathematical graph, the respective start node to the respective target node.

6. The method of claim 1 wherein determining, for each statement of the series of statements, the respective shortest path includes:
generating a queue having a front position and including thereat the constant corresponding to the respective statement;
and
performing a set of actions for a search for the respective shortest path until the respective shortest path is identified, the set of actions including:
identifying a current constant corresponding to the front position of the queue;
generating, from the current constant, a set of candidate constants by a corresponding set of predefined instructions;
removing the current constant from the queue;
adding each candidate constant to the queue;
and
identifying the respective shortest path when one candidate constant matches the constant corresponding to the respective next statement.

7. The method of claim 6 wherein the set of predefined instructions includes a loop initiation, a loop termination, and a statement continuation.

8. The method of claim 6 wherein each candidate constant is added to the queue only when the respective candidate constant, in accordance with one or more predetermined rules, advances the search towards the constant corresponding to the respective next statement.

9. The method of claim 8 wherein:
the set of actions further includes:
adding each candidate constant to a record of unique candidate constants only when the respective candidate constant, in accordance with the one or more predetermined rules, advances the search towards the constant corresponding to the respective next statement and only when the respective candidate constant is absent from the record of unique candidate constants;
and
each candidate constant is added to the queue only when the respective candidate constant, in accordance with the one or more predetermined rules, advances the search towards the constant corresponding to the respective next statement and only when the respective candidate constant is absent from the record of unique candidate constants.

10. The method of claim 1 wherein, for each statement of the series of statements, the respective shortest path is determined using one of:
a Djikstra technique;
a Floyd Warshall technique;
and
a Bellman Ford technique.

11. A method comprising, by a computing device:
receiving a computer program including one or more affine loop nests among a series of statements;
generating a representation of the computer program, the representation defining a series of constants corresponding to the series of statements, each constant indicating a respective ordering for the corresponding statement in accordance with the one or more affine loop nests;
sending, to one optimization agent of a set of optimization agents, the representation of the computer program, each optimization agent of the set of optimization agents configured to update, in accordance with the one or more affine loop nests, the representation of the computer program by a respective type of loop optimization;
receiving, from an other optimization agent of the set of optimization agents, an updated representation of the computer program modified according to the respective type of loop optimization of each optimization agent of the set of optimization agents;
and
obtaining, in accordance with the updated representation of the computer program, an updated computer program including one or more optimized loop structures among the one or more statements.

12. The method of claim 11 wherein the one optimization agent and the other optimization agent are a same optimization agent.

13. The method of claim 11 further comprising, by the computing device:
receiving, from the one optimization agent of the set of optimization agents, a partially updated representation of the computer program modified according to the respective type of loop optimization of the one optimization agent;
and
sending, to a further optimization agent of the set of optimization agents, the partially updated representation of the computer program.

14. The method of claim 13 wherein the one other optimization agent and the further optimization agent are a same optimization agent.

15. The method of claim 11 wherein each type of loop optimization is selected from the group comprising loop distribution, loop tiling, loop fusion, loop interchange, and loop parallelization.

16. The method of claim 11 wherein at least one optimization agent of the set of optimization agents is located at a further computing device coupled to the computing device.

17. A system for optimizing a computer program including one or more affine loop nests among a series of statements, the system comprising:
a lead computing device configured to:
receive the computer program;
and
generate a representation of the computer program, the representation defining a series of constants corresponding to the series of statements, each constant indicating a respective ordering for the corresponding statement in accordance with the one or more affine loop nests;
and
a set of agent computing devices coupled to the lead computing device and each configured to:
receive, from the lead computing device or one other agent computing device of the set of further computing devices, the representation of the computer program;
determine, for each statement of the series of statements, a respective shortest path between the constant corresponding to the respective statement and the constant corresponding to a respective next statement among the series of statements, each shortest path defining a respective set of one or more predefined instructions for transitioning between the respective statement and the respective next statement;
identify, in accordance with the respective shortest path of each statement of the series of statements, the one or more affine loop nests of the computer program;
modify, in accordance with the one or more affine loop nests of the computer program, the representation of the computer program with at least one loop transformation corresponding to a respective type of loop optimization;
and
provide the representation of the computer program.

18. The system of claim 17 wherein the lead computing device is further configured to:
receive, from one agent computing device of the set of agent computing devices, the representation of the computer program modified according to the respective type of loop optimization of each agent computing device of the set of agent computing devices;
and
obtain, in accordance with the representation of the computer program received from the one agent computing device, an updated computer program including one or more optimized loop structures among the one or more statements.

19. The system of claim 17 wherein each predefined instruction is selected from the group consisting of loop initiation, loop termination, and statement continuation.

20. The system of claim 17 wherein each type of loop optimization is selected from the group comprising loop distribution, loop tiling, loop fusion, loop interchange, and loop parallelization.
